(19) United States
(12) Patent Application Publication
(10) Pub. No.: US 2016/0069801 A1
(43) Pub. Date: Mar. 10, 2016

(54) PARTICULATE MATTER SENSOR

(71) Applicant: Leeo, Inc., Palo Alto, CA (US)

(72) Inventors: Andrew G. STEVENS, Palo Alto, CA (US); Steven SENSARN, Palo Alto, CA (US)

(73) Assignee: Leeo, Inc., Palo Alto, CA (US)

(21) Appl. No.: 14/480,307

(22) Filed: Sep. 8, 2014

(51) Int. Cl. G01N 21/47; H04N 5/225; G06T 7/60; G01N 21/49

(52) U.S. Cl. CPC G01N 21/4788; G01N 21/49; H04N 5/2253; G06T 7/60; G06T 2207/10004; G06T 2207/30242

(57) ABSTRACT

An electronic device that obtains information about particles is described. This electronic device includes an imaging system that captures one or more images of the particles in a flowing fluid using an optical beam that is at an angle or approximately perpendicular to an average flow direction. In particular, the optical beam from an optical source is diffracted by an aperture, transmitted through a protective mechanism, and captured by an imaging sensor. The one or more images may include diffraction patterns of a subset of the particles deposited on the top surface. Moreover, the one or more images may be analyzed by the electronic device and/or remotely from the electronic device to determine the information about the particles, such as: types of particles, particle sizes, and/or a particle count. Note that the analysis may use signal processing to obtain a resolution that is less than a resolution of the one or more images.

### BACKGROUND

1. Field

The described embodiments relate generally to an electronic device for detecting particulate matter. More specifically, the described embodiments relate to a technique for detecting particulate matter using an electronic device with an integrated imaging system.

2. Related Art

Trends in connectivity and in portable electronic devices are resulting in dramatic changes in people's lives. For example, the Internet now allows individuals access to vast amounts of information, as well as the ability to identify and interact with individuals, organizations and companies around the world. This has resulted in a significant increase in online financial transactions (which are sometimes referred to as ‘ecommerce’). Similarly, the increasingly powerful computing and communication capabilities of portable electronic device (such as smartphones and tablets), as well as a large and growing set of applications, are accelerating these changes, providing individuals access to information at arbitrary locations and the ability to leverage this information to perform a wide variety of tasks.

Recently, it has been proposed these capabilities be included in other electronic devices that are located throughout our environments, including: those that people interact with infrequently. In the so-called ‘Internet of things,’ it has been proposed that future versions of these so-called ‘background’ electronic devices be outfitted with more powerful computing capabilities and networking subsystems to facilitate wired or wireless communication. For example, the background electronic devices may include: a cellular network interface (LTE, etc.), a wireless local area network interface (e.g., a wireless network such as described in the Institute of Electrical and Electronics Engineers (IEEE) 802.11 standard or Bluetooth™ from the Bluetooth Special Interest Group of Kirkland, Wash.), and/or another type of wireless interface (such as a near-field-communication interface). These capabilities may allow the background electronic devices to be integrated into information networks, thereby further transforming people's lives.

However, the overwhelming majority of the existing background electronic devices in people's homes, offices and vehicles have neither enhanced computing capabilities (such as processor that can execute a wide variety of applications) nor networking subsystems. Given the economics of many market segments (such as the consumer market segment), these so-called ‘legacy’ background electronic devices (which are sometimes referred to as “legacy electronic devices”) are unlikely to be rapidly replaced.

These barriers to entry and change are obstacles to widely implementing the Internet of things. For example, in the absence of enhanced computing capabilities and/or networking subsystems it may be difficult to communicate with the legacy electronic devices. Furthermore, even when electronic devices include enhanced computing capabilities and/or networking subsystems, power consumption and battery life may limit the applications and tasks that can be performed. In addition, it is often difficult to use the legacy electronic devices.

### SUMMARY

The described embodiments relate to an electronic device that includes a housing having an input port and an output port, where the input port conveys a fluid, having an average flow direction and that includes particles, into an interior of the electronic device, and the output port conveys the fluid out of the interior of the electronic device. Moreover, the electronic device includes: an optical source that provides an optical beam having a wavelength; an aperture that receives the optical beam and provides, at an angle or approximately perpendicular to the average flow direction, as diffracted optical beam in the interior of the electronic device; a protective mechanism, having a top surface and a bottom surface, which transmits the wavelength; and an imaging sensor, positioned beneath the bottom surface, which captures one or more images that include diffraction patterns associated with a subset of the particles deposited on the top surface. Furthermore, the electronic device includes an interface circuit that communicates the one or more images to a second electronic device to analyze the one or more images and determine information about the particles.

Note that the aperture may include a pin-hole aperture. Moreover, the information may include: composition of the particles, types of particles, particle sizes, and/or a particle count.

In some embodiments, the electronic device includes a cleaning mechanism that cleans the subset of the particles disposed on the top surface. For example, the cleaning mechanism may be included in an adjustable shutter, and the cleaning mechanism may clean the top surface when the adjustable shutter is displaced over the protective mechanism. Alternatively or additionally, the cleaning mechanism may include a tape that is displaced over the top surface.

Furthermore, the interface circuit may communicate a maintenance notification to a third electronic device, where the maintenance notification includes: an instruction to clean the top surface, and/or an instruction to replace the protective mechanism.

Additionally, the electronic device may exclude a lens, and the second electronic device may use signal processing to obtain a resolution that is less than a resolution of the one or more images. However, the electronic device may include a lens between the bottom surface and the imaging sensor.

In some embodiments, the electronic device includes an optical filter, between the bottom surface and the imaging sensor, which filters the diffracted optical beam after the protective mechanism. For example, the optical filter may be disposed on the bottom surface.

Moreover, at least one of the input port and the output port may include adjustable baffles that adjust a flow of the fluid. Furthermore, the electronic device may include a forced-fluid driver that generates the flow. This forced-fluid driver may include: a pump, a fan, a thermal mechanism, and/or an electrostatic mechanism.

Note that the wavelength may be in: a visible band of wavelengths, and/or an infra-red band of wavelengths.

Another embodiment provides an electronic device that includes: the housing, the optical source, the aperture, the protective mechanism, and the imaging sensor. In addition, the electronic device includes an integrated circuit that analyzes the one or more images to determine information about the particles.

Another embodiment provides a method for obtaining information about particles, which may be performed by one of the embodiments of the electronic device described previously. During operation, the electronic device creates the flow of the fluid, having the average flow direction and including the particles, into the interior of the electronic device. Then, the electronic device provides the optical beam from the optical source in the electronic device. Moreover, using the aperture in the optical source, the electronic device generates, at an angle or approximately perpendicular to the average flow direction, the diffracted optical beam in the interior of the electronic device. Next, using the imaging sensor in the electronic device, the electronic device captures the one or more images that include the diffraction patterns associated with the subset of the particles deposited on the top surface of a protective mechanism positioned above the imaging sensor. Furthermore, the electronic device analyzes the one or more images to determine the information about the particles.

The preceding summary is provided as an overview of some exemplary embodiments and to provide a basic understanding of aspects of the subject matter described herein. Accordingly, the above-described features are merely examples and should not be construed as narrowing the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an electronic device accordance with an embodiment of the present disclosure.

FIG. 2 is a block diagram illustrating an electronic device in FIG. 1 in accordance with an embodiment of the present disclosure.

FIG. 3 is a flow diagram illustrating a method for obtaining information about particles in accordance with an embodiment of the present disclosure.

FIG. 4 is a drawing illustrating communication within the electronic device of FIG. 1 during the method of FIG. 3 in accordance with an embodiment of the present disclosure.

FIG. 5 is a drawing illustrating operation of the electronic device of FIG. 1 during the method of FIG. 3 in accordance with an embodiment of the present disclosure.

FIG. 6 is a drawing illustrating cleaning of a protective mechanism in the electronic device of FIG. 1 in accordance with an embodiment of the present disclosure.

FIG. 7 is a drawing illustrating cleaning of a protective mechanism in the electronic device of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that obtains information about particles is described. This electronic device includes an imaging system that captures one or more images of the particles in a flowing fluid using an optical beam that is at an angle or approximately perpendicular to an average flow direction. In particular, the optical beam from an optical source is diffracted by an aperture, transmitted through a protective mechanism, and captured by an imaging sensor. The one or more images may include diffraction patterns of a subset of the particles deposited on the top surface. Moreover, the one or more images may be analyzed by the electronic device and/or remotely from the electronic device to determine the information about the particles, such as: types of particles, particle sizes, and/or a particle count. Note that the analysis may use signal processing to obtain a resolution that is less than a resolution of the one or more images.

In this way, the electronic device may allow information about the particles to be determined. Moreover, the electronic device may determine the information without the use of a lens and/or local analysis, which may allow the electronic device to provide a compact and low-cost way to monitor an environmental condition in an external environment that includes the electronic device. The resulting improved, functionality offered by the electronic device may promote sales of the electronic device (and, more generally, commercial activity) and may enhance customer satisfaction with the electronic device.

Note that this environmental-monitoring technique is not an abstract idea. In particular, the environmental monitoring in the embodiments of the environmental-monitoring technique is not: a fundamental economic principle, a human activity (the operations in the environmental-monitoring technique typically involve measurements in noisy environments), and/or a mathematical relationship/formula. Moreover, the environmental-monitoring technique amounts to significantly more than an alleged abstract idea. In particular, the environmental-monitoring technique may improve the functioning of the electronic device that executes software and/or implements the environmental-monitoring technique. For example, the environmental-monitoring technique may: speed up computations performed during the environmental-monitoring technique (such as the analysis); reduce memory consumption when performing the computations; improve reliability of the computations (as evidenced by improved monitoring of the information about the particles and, more generally, the environmental condition); improve the user-friendliness of a user interface that displays results of the measurements or the analysis (e.g., by allowing a user to view information about the particles and/or the environmental condition); and/or improve other performance metrics related to the function of the electronic device. Furthermore, the measurements performed by the electronic device constitute a technical effect in which information is transformed.

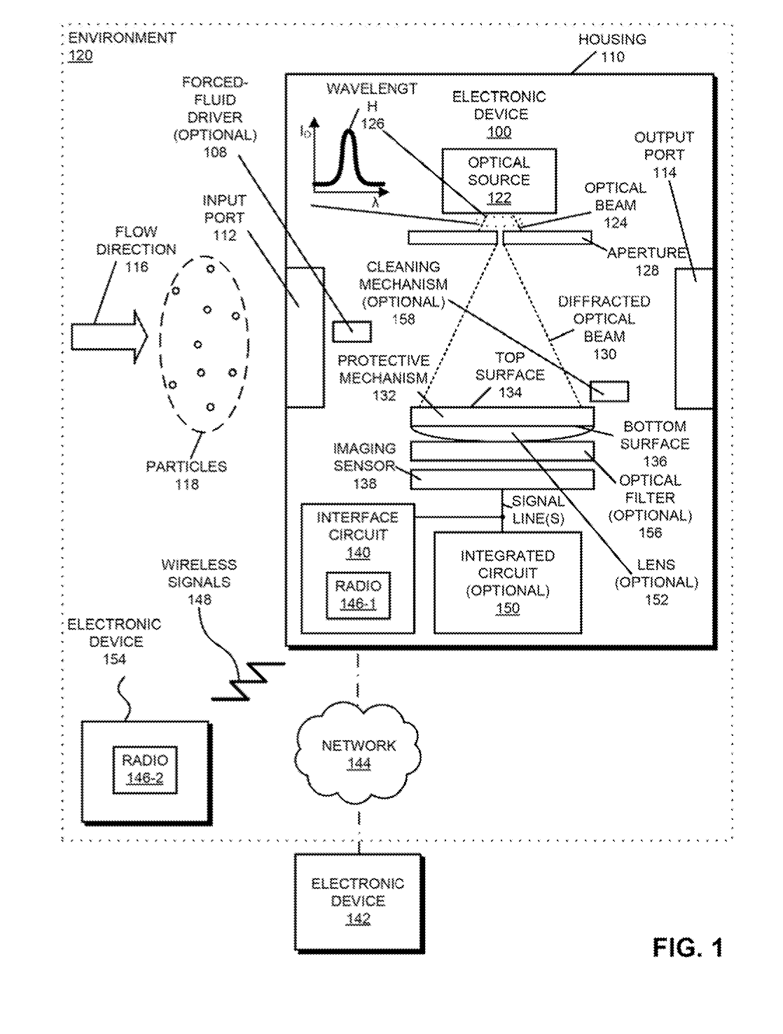

We now describe embodiments of the electronic device. FIG. 1 presents a block diagram illustrating an embodiment of electronic device 100. This electronic device includes a housing 110 having an input port 112 and an output port 114, where input port 12 conveys a fluid (such as a liquid or air), having an average flow direction 116 and that includes particles 118, into an interior of electronic device 100, and output port 114 conveys the fluid out of interior of electronic device 100 (i.e., into external environment 120). For example, at least one of input port 112 and output port 114 may include adjustable baffles that adjust a flow of the fluid. In some embodiments, electronic device 100 includes an optional forced-fluid driver 108 that generates the flow of the fluid. This optional forced-fluid driver may include: a pump, a fan, a thermal mechanism, and/or an electrostatic mechanism.

Moreover, electronic device 100 includes: an optical source 122 that provides an optical beam 124 having at least a wavelength 126 (such as a wavelength or a band of wavelengths in the visible and/or infra-red bands of wavelengths); and an aperture 128 (such as a pin-hole aperture) that receives optical beam 124 and provides a diffracted optical beam 130 at an angle (such as 45°) or approximately perpendicular to average now direction 116 (such as within 5 or 10°of perpendicular) in the interior of electronic device 100.

Furthermore, electronic device 100 includes: a protective mechanism 132 (such as a glass slide), having a top surface 134 and a bottom surface 136, which transmits wavelength 126; and an imaging sensor 138 (such as a CCD or CMOS imaging sensor), positioned beneath bottom surface 136, which captures one or more images that include diffraction patterns associated with a subset of particles 118 deposited on or disposed on top surface 134.

Additionally, electronic device 100 includes an interface circuit 140 that communicates the one or more images to electronic device 142 (such as a server or a computer). For example, electronic device 100 may communicate packets with the one or more images to electronic device 142 via network 144 (such as the Internet, a wireless local area network, an Ethernet network, an intra-net, an optical network, etc.). Thus, the communication may involve wired, optical and/or wireless communication.

Electronic device 142 may analyze the one or more images and determine information about particles 118. This information may include: composition of particles 118, types of particles, particle sizes, and/or a particle count. Once the information is determined, electronic device 142 may provide the information (and, more generally, analysis results, such as the environmental condition) to electronic device via network 144.

Note that electronic device 100 may exclude a lens, and electronic device 142 may use signal processing to obtain a resolution that is less than a resolution of the one or more images. For example, a superresolution technique may be used to enhance the resolution of the one or more images by overcoming the diffraction limn associated with aperture 128 (so-called ‘optical superresolution’) and/or resolution limits associated with imaging sensor 138 (so-called ‘geometric superresolution’). In particular, if the one or more images are assumed to be stationary (i.e., object invariance), information outside a spatial-frequency band beyond a cutoff frequency associated with the optical path in electronic device 100 can be swapped with information in a spatial-frequency band below the cutoff frequency to overcome the diffraction limit. In addition, the one or more images may be used to reduce noise in the images. This can range from averaging of the one or more images, to the use of single-frame deblurring, sub-pixel image localization, Gaussian deblurring and/or Bayesian induction. Thus, the analysis may involve a single and/or a multi-image analysis technique.

If electronic device 100 can avoid using a lens, the cost and weight of electronic device 100 may be reduced. However, in other embodiments electronic device 100 includes an optional lens 152 between bottom surface 136 and imaging sensor 138. In these embodiments, the one or more images may be acquired or captured at different depths of focus of imaging sensor 138, so that the one or more images may be combined during the analysis to reconstruct the amplitude and the phase at an arbitrary distance from imaging sensor 138. This analysis technique may also be used to increase the resolution relative to that of the one or more images.

In addition, there may be an optional optical filter 156, between bottom surface 136 and imaging sensor 138 (such as a layer deposited on or disposed on bottom surface 136 and/or on or in optional lens 152), which filters diffracted optical beam 130 after protective mechanism 132. For example, optional filter 156 may attenuate or remove one or more wavelengths in diffracted optical beam 130.

Alternatively or additionally, electronic device may include optional integrated circuit 150, which performs the analysis separately from or in conjunction with electronic device 142. For example, the one or more images may be pre-processed by optional integrated circuit 150 (such as pre-filtering of noise in the one or more images, resampling of the one or more images, changing the format of the one or more images. etc.) and/or optional integrated circuit 150 may perform the analysis when communication with electronic device 142 is unavailable.

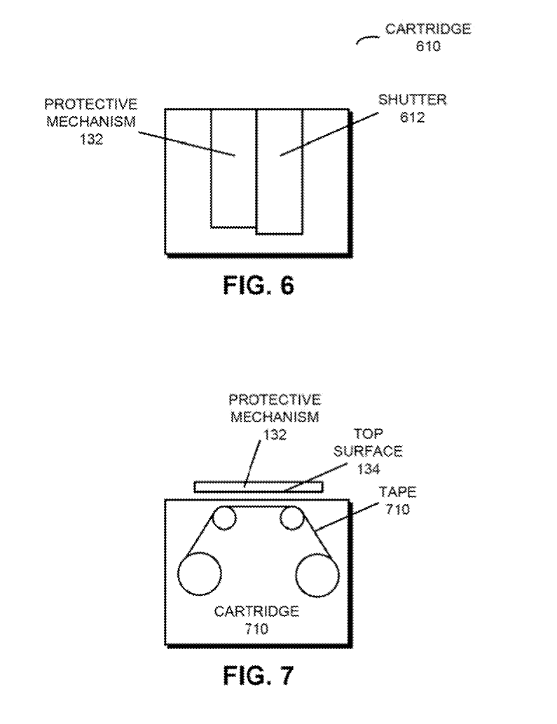

As described below with reference to FIGS. 6 and 7, electronic device 100 may include an optional cleaning mechanism 158 that cleans the subset of particles 118 disposed on top surface 134. For example, optional cleaning mechanism 158 may be included in an adjustable shutter, and optional cleaning mechanism 158 may clean top surface 134 when the adjustable shutter is displaced over protective mechanism 132. Alternatively or additionally, optional cleaning mechanism 58 may include a tape that is displaced (periodically or as needed) over top surface 134.

Alternatively or additionally, interface circuit 140 may communicate a maintenance notification to electronic device 154 (such as a user's cellular telephone), where the maintenance notification includes: an instruction to clean top surface 134, and/or an instruction to replace protective mechanism 132. For example, protective mechanism 132 and optional cleaning mechanism 158 may be included in a removable cartridge. More generally, interface circuit 140 may also communicate the information about particles 118 to electronic device 154.

Note that communication among electronic devices 100, 142 and/or 154 may include wireless communication. Consequently, packets with information may be included in frames in one or more wireless channels. In particular, interface circuit 140 may include a radio 146-1 that transmits wireless signals 148 (illustrated by a jagged line), e.g., to electronic device 154, which are received by radio 146-2. In general, the wireless communication between electronic devices 100, 142 and 154 may or may not involve a connection being established among these electronic devices, and therefore may or may not involve communication via a wireless network.

In these ways, electronic device 100 may determine the information about particles 118. The determined information (and, more generally, the environmental condition, which may correspond to or may be related to the information) may facilitate a variety of services and improved functionality of the electronic devices in FIG. 1. For example, services may be offered to: users associated with electronic devices 100, 142 and/or 154 (such as owners or renters of these electronic devices), suppliers of components or spare parts, maintenance personnel security personnel, emergency service personnel, insurance companies, insurance brokers, realtors, leasing agents, apartment renters, hotel guests, hotels, restaurants, businesses, organizations, governments, potential buyers of physical objects, a shipping or transportation company, etc. In particular, the determined information may allow the function or operation of one or more electronic devices in FIG. 1 (such as a legacy electronic device and/or a regulator device, which may or may not directly communicate information with electronic devices 100, 142 and/or 154) to be adapted or changed. In this way, an environmental condition (such as an allergen count, the temperature, humidity, an illumination pattern, etc.) in external environment 120 may be dynamically modified. In addition, the service(s) may include maintenance notifications about electronic devices 100, 142 and/or 154. For example, as noted previously, based on the determined information, electronic device 100 may provide a maintenance notification to the user's cellular telephone to perform a remedial action (such as a repair or service to be performed on electronic device 100).

Although we describe the environment shown in FIG. 1 as an example, in alternative embodiments different numbers or types of components may be present. For example, some embodiments comprise more or fewer components, components may be at different positions and/or two or more components may be combined into a single component.

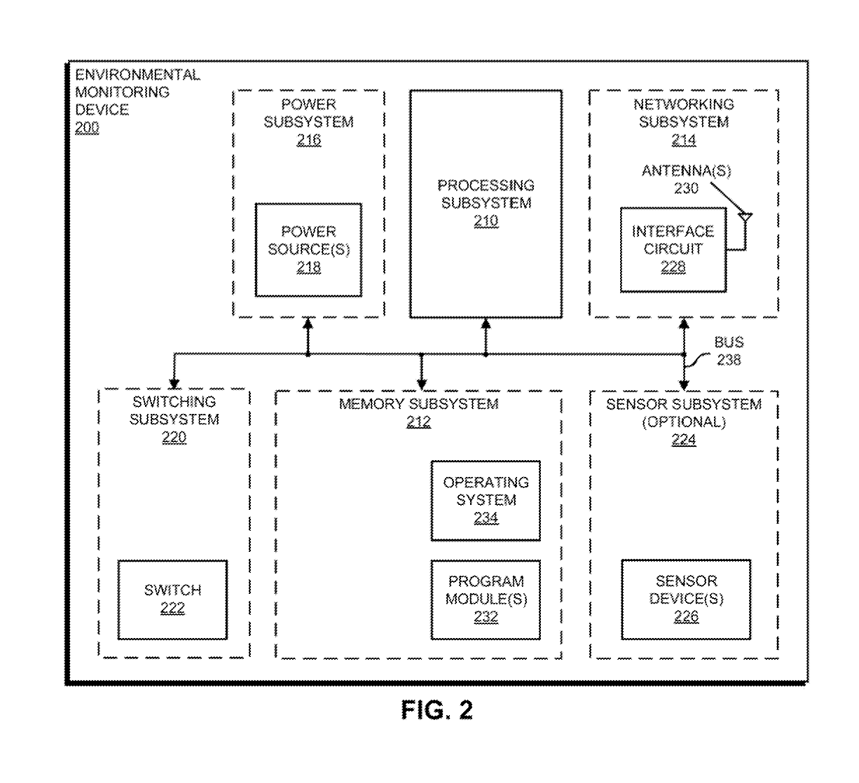

FIG. 2 presents a block diagram illustrating an embodiment an electronic device 200, which may be electronic device 100 or 142 (FIG. 1). This electronic device includes processing subsystem 210 (and, more generally, an integrated circuit or a control mechanism), memory subsystem 212, a networking subsystem 214, power subsystem 216, switching subsystem 220, and/or optional sensor subsystem 224 (i.e., a data-collection subsystem and, more generally, a sensor mechanism). Processing subsystem 210 includes one or more devices configured to perform computational operations and to execute techniques to process sensor data. For example, processing subsystem 210 can include one or more microprocessors, application-specific integrated circuits (ASICs), microcontrollers, programmable-logic devices, and/or one or more digital signal processors (DSPs).

Memory subsystem 212 includes one or more devices for storing data and/or instructions for processing subsystem 210, networking subsystem 214, and/or optional sensor subsystem 224. For example, memory subsystem 212 can include dynamic random access memory (DRAM), static random access memory (SRAM), and/or other types of memory. In some embodiments, instructions for processing subsystem 210 in memory subsystem 212 include: one or more program modules 232 or sets of instructions, which may be executed in an operating environment (such as operating system 234) by processing subsystem 210. Note that the one or more computer programs may constitute a computer-program mechanism or a program module. Moreover, instructions in the various modules in memory subsystem 212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 210.

In addition, memory subsystem 212 can include mechanisms for controlling access to the memory. In some embodiments, memory subsystem 212 includes a memory hierarchy that comprises one or more caches coupled to a memory in electronic device 200. In some of these embodiments, one or more of the caches is located in processing subsystem 210.

In some embodiments, memory subsystem 212 is coupled to one or more high-capacity mass-storage devices (not shown). For example, memory subsystem 212 can be coupled to a magnetic or optical drive, a solid-state drive, or another type of mass-storage device. In these embodiments, memory subsystem 212 can be used by electronic device 200 as fast-access storage for often-used data, while the mass-storage device is used to store less frequently used data.

Networking subsystem 214 includes one or more devices configured to couple to and communicate on a wired, optical and/or wireless network (i.e., to perform network operations and, more generally, communication), including an interface circuit 228 (such as a ZigBee® communication circuit) and one or more antennas 230. For example, networking subsystem 214 may include: a ZigBee® networking subsystem, a Bluetooth™ networking system (which can include Bluetooth™ Low Energy, BLE or Bluetooth™ LE), a cellular networking system (e.g., a 3G/4G network such as (UMTS, LTE, etc.), a USB networking system, a networking system based on the standards described in IEEE 802.11 (e.g., a networking system), an Ethernet networking system, an infra-red communication system, a power-line communication system and/or another communication system (such as a near-field-communication system or an ad-hoc-network networking system).

Moreover, networking, subsystem 214 includes processors, controllers, radios/antennas, sockets/plugs, and/or other devices used for coupling to, communicating on, and handling data and events for each supported networking or communication system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 200 may use the mechanisms in networking subsystem 214 for performing simple wireless communication between electronic device 200 and other electronic devices, e.g., transmitting advertising frames, petitions, beacons and/or information associated with near-field communication.

Moreover, electronic device 200 may include power subsystem 216 with one or more power sources 218. Each of these power sources may include: a battery (such as a rechargeable or a non-rechargeable battery), a DC power supply, an AC power supply, a switched-mode power supply, a regulated power supply and/or a transformer. In some embodiments, power subsystem 216 includes a recharging circuit that recharges a rechargeable battery in at least one of power sources 218. This may facilitate the recharging by converting an electrical signal in power subsystem 216 into a DC or an AC electrical signal that is suitable for recharging the rechargeable battery. Furthermore, the one or more power sources 218 may operate in a voltage-limited mode or a current-limited mode. These power sources may be mechanically and electrically coupled by a male or female adaptor to: a wall or electrical-outlet socket or plug (such as a two or three-pronged electrical-outlet plug, which may be collapsible or retractable), a light socket for light-bulb socket), electrical wiring (such as a multi-wire electrical terminal), a generator, a USB port or connector, a DC-power plug or socket, a cellular-telephone charger cable, a photodiode, a photovoltaic cell, etc. This mechanical and electrical coupling may be rigid or may be remateable. Note that the one or more power sources 218 may be mechanically and electrically coupled to an external power source or another electronic device by one Of the electrical-connection nodes in switch 222 in switching subsystem 220.

In some embodiments, power subsystem 216 includes or functions as a pass-through power supply for one or more electrical connectors to an external electronic device (such as an appliance or a regulator device) that can be plugged into the one or more electrical connectors. Power to the one or more electrical connectors (and, thus, the external electronic device) may be controlled locally by processing subsystem 210, switching subsystem 220 (such as by switch 222), and/or remotely via networking subsystem 214.

In addition to the imaging sensor described previously, optional sensor subsystem 224 may include one or more sensor devices 226 (or a sensor array), which may include one or more processors and memory. For example, the one or more sensor devices 226 may include: a thermal sensor (such as a thermometer), a humidity sensor, a barometer, a camera or video recorder (such as a CCD or CMOS imaging sensor), one or more microphones (which may be able to record acoustic information, including acoustic information in an audio band of frequencies, in mono or stereo), a load-monitoring sensor or an electrical-characteristic detector (and, more generally a sensor that monitors one or more electrical characteristics), an infrared sensor (which may be active or passive), a microscope, a particle detector (such as a detector of dander, pollen, dust, exhaust, etc.), an air-quality sensor, a particle sensor, an optical particle sensor, an ionization particle sensor, a smoke detector (such as an optical smoke detector or an ionizing smoke detector), a fire-detection sensor, a radon detector, a carbon-monoxide detector, a chemical sensor or detector, a volatile-organic-compound sensor, a combustible gas sensor, a chemical-analysis device, a mass spectrometer, a microanalysis device, a nano-plasmonic sensor, a genetic sensor (such as a micro-array), an accelerometer, a position or a location sensor (such as a location sensor based on the Global Positioning System or GPS), a gyroscope, a motion sensor (such as a light-beam sensor), a contact sensor, a strain sensor (such as a strain gauge), a proximity sensor, a microwave/radar sensor (which may be active or passive), an ultrasound sensor, a vibration sensor, a fluid flow sensor, a photo-detector, a Geiger counter, a radio-frequency radiation detector, and/or another device that measures a physical effect or that characterizes an environmental factor or physical phenomenon (either directly or indirectly). Note that the one or more sensor devices 226 may include redundancy (such as multiple instances of a type of sensor device) to address sensor failure or erroneous readings, to provide improved accuracy and/or to provide improved precision.

During operation of electronic device 200, processing subsystem 210 may execute one or more program modules 232, such as an environmental-monitoring application that uses one or more sensor devices 226 to measure environmental signals associated with an external environment that includes electronic device 200. The resulting measurements may be analyzed by the environmental-monitoring application to identify or determine an environmental condition associated with the external environment (such as the information about the particles or a related environmental condition, e.g., the presence of an open window or door, a setting of an air filter, etc). Moreover, the environmental condition may be used by the environmental-monitoring application to modify operation of electronic device and/or the external electronic device (such as a regulator device), and/or to provide information about the external environment to another (separate) electronic device (e.g., via networking subsystem 214). For example, based on the information about the particles, the environmental-monitoring application may determine that a regulator device needs to be turned on (or off) to change an environmental condition. Then, the environmental-monitoring application may change a state of switch 222 so that the regulator device is electrically coupled (or decoupled) from one of the one or more power sources 218. In this way, electronic device 200 may respond to the measurements an that an environmental condition (such as the temperature, humidity, a lighting condition, an allergen level, etc. in the external environment can be dynamically modified.

Within electronic, device 200, processing subsystem 210, memory subsystem 212, networking subsystem 214, power subsystem 216, switching subsystem 220, and/or optional sensor subsystem 224 may be coupled using one or more interconnects, such as bus 236. These interconnects may include an electrical, optical, and/or electro-optical connection that the subsystems can use to communicate commands and data among one another. Note that different embodiments can include a different number or configuration of electrical, optical, and/or electro-optical connections among the subsystems.

Electronic device 200 can be (or can be included in) a wide variety of electronic devices. For example, electronic device 200 can be (or can be included in): a sensor (such as a smart sensor), a tablet computer, a smartphone, a cellular telephone, an appliance, a regulator device, a consumer-electronic device (such as a baby monitor), a portable computing device, test equipment, a digital signal processor, a controller, a personal digital assistant, a laser printer (or other office equipment such as a photocopier), a personal organizer, a toy, a set-top box, a computing device (such as a laptop computer, a desktop computer, a server, and/or a subnotebook/netbook), a light (such as a nightlight), an alarm, a smoke detector, a carbon-monoxide detector, a monitoring device, and/or another electronic device (such as a switch or a router).

Although specific components are used to describe electronic device 200, in alternative embodiments, different components and/or subsystems may be present in electronic device 200. For example, electronic device 200 may include one or more additional processing subsystems, memory subsystems, networking subsystems, power subsystems, switching subsystems, and/or sensor subsystems. Additionally, one or more of the subsystems may not be present in electronic device 200. Moreover, in some embodiments, electronic device 200 may include one or more additional subsystems that are not shown in FIG. 2, such as a display subsystem, a user-interface subsystem, and/or a feedback subsystem (which may include speakers and/or an optical source).

Although separate subsystems are shown in FIG. 2, in some embodiments, some or all of a given subsystem or component can be integrated into one or more of the other subsystems or components in electronic device 200. For example, in some embodiments the one or more program modules 232 are included in operating system 234. In some embodiments, a component in a given subsystem is included in a different subsystem.

Moreover, the circuits and components in electronic device 200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement: some or all of the functionality of networking subsystem 214 (such as a radio) and, more generally, some or all of the functionality of electronic device 200. Moreover, the integrated circuit may include hardware and/or software mechanisms that are used for transmitting wireless signals from electronic device 200 to, and receiving signals at electronic device 200 from other electronic devices. Aside from the mechanisms herein described, radios are generally known in the art and hence are not described in detail. In general, networking subsystem 214 and/or the integrated circuit can include any number of radios. Note that the radios in multiple-radio embodiments function in a similar way to the radios described in single-radio embodiments.

In some embodiments, networking subsystem 214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, a petition, a beacon, etc)

While some of the operations in the preceding embodiments were implemented in hardware or software, in general the operations in the preceding embodiments can be implemented in a wide variety of configurations and architectures, Therefore, some or all of the operations in the preceding embodiments may be performed in hardware, in software or both.

Note that aspects of the environmental-monitoring technique may be implemented using an integrated circuit. In some embodiments, an output of a process for designing an integrated circuit, or a portion of an integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design interchange Format (EDIF). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

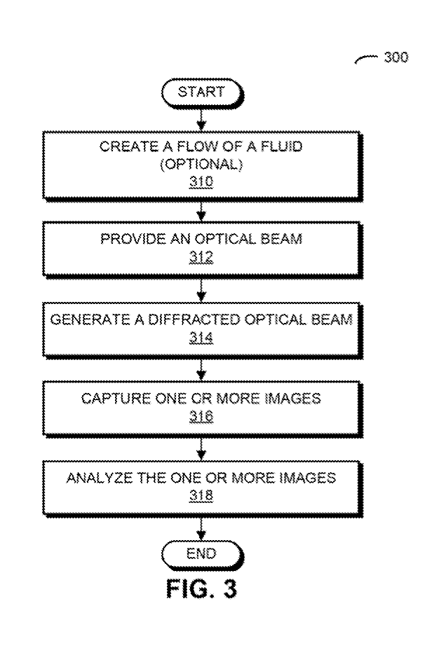

We now further describe the environmental-monitoring technique and operation of the electronic device. FIG. 3 presents a flow diagram illustrating a method 300 for obtaining information about particles, which may be performed by electronic device 100 (FIG. 1). During operation, the electronic device optionally creates a flow of a fluid (operation 310), having an average flow direction and including particles, into an interior of the electronic device. Then, the electronic device provides an optical beam (operation 312) from an optical source in the electronic device. Moreover, using an aperture in the optical source, the electronic device generates, at an angle or approximately perpendicular to the average flow direction, a diffracted optical beam (operation 314) in the interior of the electronic device. Next, using an imaging sensor in the electronic device, the electronic device captures (or acquires) one or more images (operation 316) that include diffraction patterns associated with a subset of the particles deposited on a top surface of a protective mechanism positioned above the imaging sensor. Furthermore, the electronic device analyzes the one or more images (operation 318) to determine the information about the particles. For example, the analysis may be performed on the electronic device and/or on another electronic device (such as a remote computer or server).

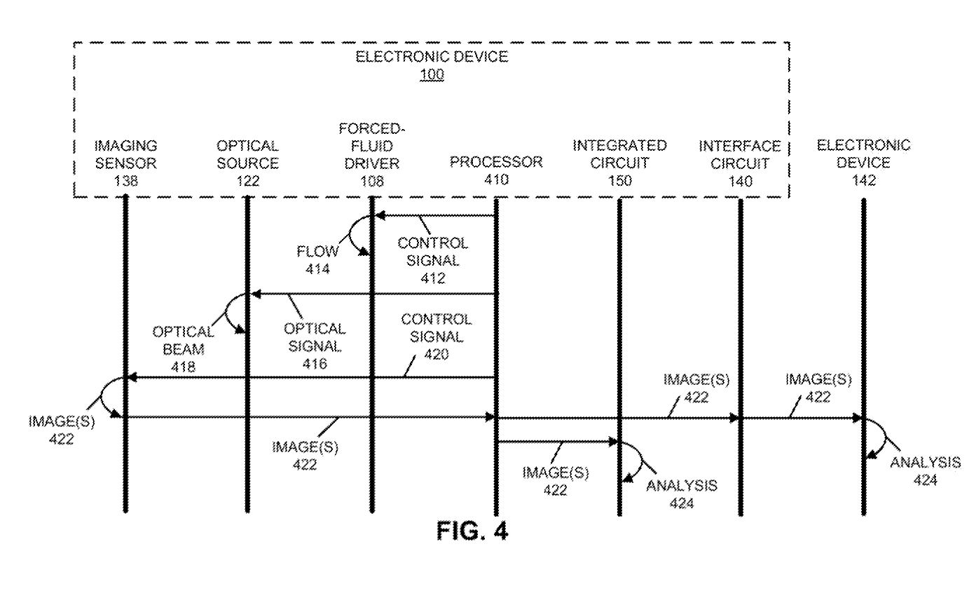

FIG. 4 presents a drawing illustrating communication within electronic device 100 (FIG. 1) during method 300 (FIG. 3). During operation, processor 410 provides a control signal 412 to forced-fluid driver 108, which creates a flow 414 of fluid (which includes particles) into electronic device 100. Moreover, processor 410 provides a control signal 416 to optical source 122, which provides an optical beam 418 at an angle or approximately perpendicular to the flow.

Then, processor 410 provides a control signal 420 to imaging sensor 138, which captures one or more images 422 that include diffraction patterns associated with a subset of the particles deposited on a top surface of a protective mechanism positioned above imaging sensor 138.

Next, processor 410 optionally provides the one or more images 422 to interface circuit 140, which communicates the one or more images 422 to electronic. device 142 for analysis 424. Alternatively or additionally, processor 410 optionally provides the one or more images 422 to integrated circuit 150, which, separately or in conjunction with electronic device 142, performs analysis 424.

While sonic of the preceding embodiments illustrated components in the electronic performing operations in the environmental-monitoring technique, in other embodiments at least some of these operations are performed by a processor in electronic. device 100 (i.e., at least some of the operations may be performed by software executed by the processor).

In some embodiments of one or more of the preceding methods, there may be additional or fewer operations. Furthermore, the order of the operations may be changed, and/or two or more operations may be combined into a single operation. In addition, in some of the preceding embodiments there are fewer components, more components, a position of a component is changed and/or two or more components are combined.

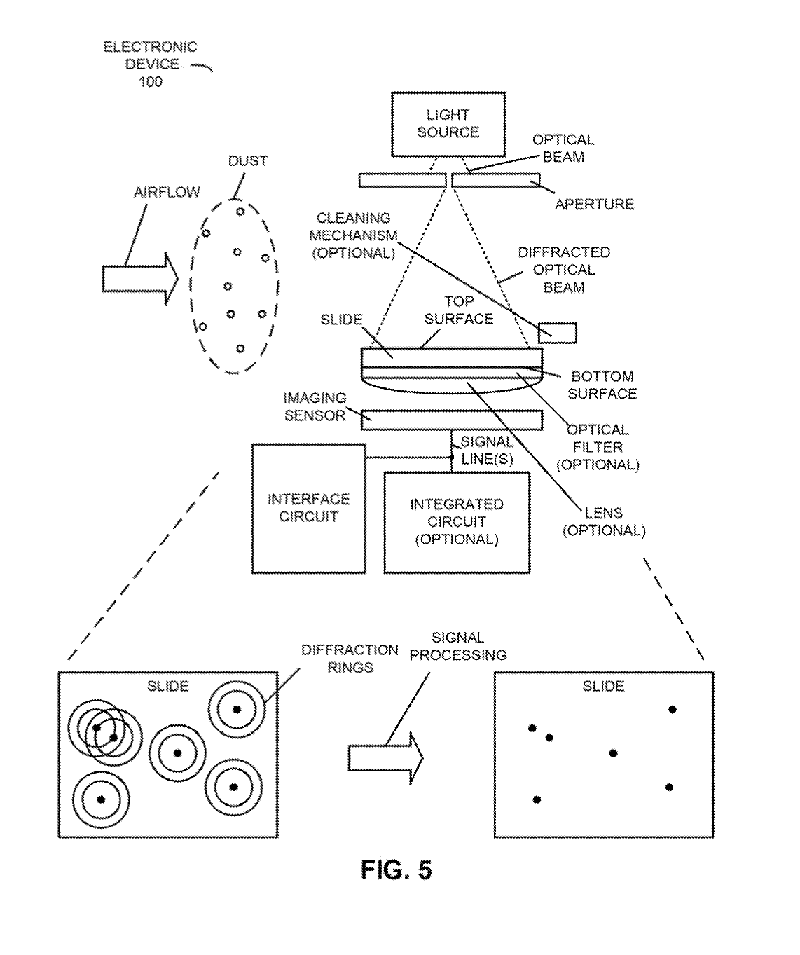

We describe examples of operation of the electronic device. FIG. 5 presents a drawing illustrating operation of electronic device 100 (FIG. 1) during method 300 (FIG. 3). In particular, a dust stream may be carried by airflow into the electronic device. The intake port to the electronic device (not shown) may include baffles, which can be adjusted via a control loop or manually to modify the airflow into the electronic device. Alternatively, the electronic device may be rotated (relative to the airflow) to modify the airflow into the electronic device. In some embodiments, a fan, a blower, an electrostatic mechanism (that attracts dust via an electrostatic force) and, more generally, a forced-fluid driver (not shown) is used to generate tile airflow through the electronic device and/or to attract charged or dielectric particles (which can have an induced charge in the presence of an electric field).

A light source, such as a light emitting diode, a lamp and/or a laser, may provide an optical beam. Note that the light source can provide an optical beam that includes wavelengths in the infra-red, such as: between 800-900 nm or at 1550 nm. The use of infra-red light may allow the use of higher power (and, thus, an optical beam with higher intensity) because it is outside of the regulated range for visible light, in addition, the use of infrared light may allow the imaging sensor to avoid noise associated with ambient light. However, in some embodiments the light sources outputs an optical beam having wavelengths in the visible spectrum. The wavelength of the light source can be adjusted or selected based upon absorption profiles of particles, e.g., a green mold can work well, with red light (as the green light is scattered while the red is absorbed by the mold), and dust particles can be white or gray, so in one variation, infra-red light can be used with dust particles.

The optical beam may pass through an aperture. This aperture may include a pin hole. Alternatively, the aperture ma include a diffraction slit or a diffraction grating. Note that the aperture may produce a uniform beam of light (i.e., the diffracted optical beam) that illuminates the protective mechanism, such as a slide. For example, the distance between the aperture and the top surface of the slide may be between 2 and 5 cm, which may correspond to an aperture diameter of 100 μm. A larger aperture diameter may be associated with a larger distance between the aperture and top surface. In particular, an aperture diameter of 50 μm may have a corresponding distance between an aperture and the top surface of approximately 1-3 cm. The size of the aperture and the distance between the aperture and top surface may depend on the amount of fluctuation in the light intensity per radian (e.g., the noise per radian), so that the size of the aperture and the distance to the top surface may be correlated. In some embodiments, the light wavefront is nominally a plane wave across the entire field of sampling (e.g., the entire top surface). Note that, in general, the angular variation of the light wavefront may be reduced with smaller apertures, with the limiting case of a point source generating a spherical wavefront. However, a smaller aperture may block more of the light, so there may be a balance between the amount of light needed to properly illuminate the particles and the compact spacing between the aperture and the slide.

Moreover, the airflow may deposit (or dispose) a subset of the particles on a top surface of the slide. For example, the slide may include: glass, tape, indium tin oxide and/or a material that is transparent for wavelengths in the optical beam.

In some embodiments, the electronic device includes an optional optical filter. While FIG. 5 illustrates the optional optical filter disposed on the bottom surface of the slide, in other embodiments the optional optical filter is positioned above the slide. For example, the slide may include a coating on the top surface of the slide that acts as an optical filter for certain wavelengths in the optical beam. Note that the optional optical filter may be a neutral density filter (for uniform filtering) or a spectral density filter. In some embodiments, the optional optical filter includes colored glass (which may provide a low-cost optical filter). Alternatively or additionally, the optional optical filter may have high optical quality to avoid distorting the light passing, through the optional optical filter. In some embodiments, the optional optical filter includes an interference or dichroic filter. While more expensive, such an optical filter may provide more flexibility.

Furthermore, an imaging sensor (such as a camera) may be positioned 1-2 mm below the bottom surface of the protection mechanism to capture or acquire one or more images. For example, a CMOS/NMOS sensor and/or a CCD may be used. In some embodiments, the imaging sensor operates without a lens. Instead, signal processing (e.g., performed locally by an optional integrated circuit) and/or remotely (e.g., by a computer or a server, which communicates with electronic device 100 via an interface circuit) may achieve micron resolution (such as a resolution of between 1 and 10 μm). However, in other embodiments the electronic device includes a lens.

As shown in FIG. 5, a raw captured image may include diffraction rings around the subset of particles disposed on the slide. After signal processing, an image of the subset of particles may be obtained. Then, software may count the number of particles, determine statistics about the size of the particles (such as the mean, the standard deviation, etc.), identify types of particles (such as pollen, a microorganism, dander, etc.) and, more generally, may determine the information about the particles. In some embodiments, the types of particles are identified using electro-dielectric properties of the particles (such as a conductivity of the particles) and/or fluorescence. However, other chemical analysis and/or microanalysis techniques may be used, such as: gas chromatography, liquid chromatography, ion microprobe, electrophoresis, cyclic voltammetry, x-ray diffraction, x-ray florescence spectroscopy, Raman spectroscopy, infrared spectroscopy, mass spectrometry, energy dispersive spectroscopy, Fourier transform spectroscopy, nuclear magnetic resonance, electron paramagnetic resonance, calorimetry, absorption spectroscopy, emission spectroscopy, etc. Note that the information and/or a processed image of the particles may be provided to a user of the electronic device. For example, a processed image along with the information may be presented on a display.

Over time, the top surface of the protective mechanism may become too dirty (e.g., there may be too many particles on the top surface). As described further below with reference to FIGS. 6 and 7, the electronic device may clean the top surface, may notify the user to clean the top surface and/or to replace a cartridge. In some embodiments, the top surface of the protective mechanism is conductive so that an electrostatic force can be used to ‘shock’ or move the particles off of the top surface. Note that the electronic device may include a physical indicator (such as a hat) or a displayed virtual icon that indicates a remaining life of the protective mechanism before replacement, cleaning and/or service.

While the proceeding discussion used certain numerical values, these are for purposes of illustration and are not intended to be limiting. Thus, embodiments of the electronic device may have a wide variety of geometries and configurations.

As discussed previously, the electronic device may include an optional cleaning mechanism that periodically or as needed cleans the subset of particles off of the top surface of the protective mechanism. FIG. 6 presents a drawing illustrating cleaning of protective mechanism 132 in electronic device 100 (FIG. 1). In particular, protective mechanism 132 may be included in a cartridge 610 (such as removable cartridge). This cartridge may include an adjustable shutter 612, and a cleaning mechanism may clean top surface 134 (FIG. 1) of protective mechanism 132 when adjustable shutter 612 is displaced over protective mechanism 132. In particular, shutter 612 may displace horizontally^{,} in a similar manner to the cover of a floppy disk.

However, other cleaning techniques may be used. This is shown in FIG. 7, which presents a drawing illustrating cleaning of protective mechanism 132 in electronic device 100 (FIG. 1). In particular, a tape 712 in cartridge 710 may be displaced (periodically or as needed) over top surface 134 in order to clean the subset of particles off of protective mechanism 132. Other cleaning techniques may include the use of a squeegee, a brush and/or electrostatic cleaning. Alternatively or additionally, in some embodiments a user of the electronic device is instructed by the electronic device to wipe or clean off top surface 134.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An electronic device, comprising:
a housing having an input port and an output port, wherein, during operation, the input port conveys a fluid, having an average flow direction, into an interior of the electronic device, and the output port conveys the fluid out of the interior of the electronic device, and wherein the fluid includes particles;
an optical source that, during operation, provides an optical beam having a wavelength, wherein the optical source includes a laser;
an aperture that, during operation, receives the optical beam and to provide a diffracted optical beam in the interior of the electronic device;
a protective mechanism, having a top surface and a bottom surface, which, during operation, transmits the wavelength;
an imaging sensor, positioned beneath the bottom surface, which, during operation, captures one or more images that include diffraction patterns associated with a subset of the particles deposited on the top surface, wherein the subset includes multiple particles and the particles are stationary on the top surface; and
interface circuit, electrically coupled to the imaging sensor, which, during operation, communicates the one or more images to a second electronic device that analyzes the one or more images and determines information about the deposited particles, wherein the electronic device excludes a lens; and
wherein the second electronic device uses signal processing to obtain an image of the subset of the particles with a resolution that is less than a resolution of the one or more images based on a superresolution technique.

2. The electronic device of claim 1, wherein the aperture includes a pin-hole aperture.

3. The electronic device of claim 1, wherein the information includes one of: composition of the particles, types of particles, particle sizes, and a particle count.

4. The electronic device of claim 1, further comprising a cleaning mechanism that, during operation, cleans the subset of the particles disposed on the top surface.

5. The electronic device of claim 4, wherein the cleaning mechanism is included in an adjustable shutter; and
wherein the cleaning mechanism cleans the top surface when the adjustable shutter is displaced over the protective mechanism.

6. The electronic device of claim 4, wherein the cleaning mechanism includes a tape that is displaced over the top surface.

7. The electronic device of claim 1, wherein the interface circuit that, during operation, communicates a maintenance notification to a third electronic device; and
wherein the maintenance notification includes one of: an instruction to clean the top surface, and an instruction to replace the protective mechanism.

8. The electronic device of claim 1, wherein the resolution that is obtained using the superresolution technique is less than 2.5 μm.

9. (canceled)

10. The electronic device of claim 1, further comprising an optical filter, between the bottom surface and the imaging sensor, which, during operation, filters the diffracted optical beam after the protective mechanism.

11. The electronic device of claim 10, wherein the optical filter is disposed on the bottom surface.

12. The electronic device of claim 1, wherein at least one of the input port and the output port includes adjustable baffles that, during operation, adjust a flow of the fluid.

13. The electronic device of claim 1, further comprising a forced-fluid driver that, during operation, generates a flow of the fluid.

14. The electronic device of claim 1, wherein the one or more images include multiple images acquired at different depths of focus; and
wherein the second electronic device analyzes the multiple images to reconstruct amplitude and phase at an arbitrary distance from the imaging sensor.

15. The electronic device of claim 1, wherein the wavelength is in one of: a visible band of wavelengths, and an infra-red band of wavelengths.

16. An electronic device, comprising:
a housing having an input port and an output port, wherein, during operation, the input port conveys a fluid, having an average flow direction, into an interior of the electronic device, and the output port conveys the fluid out of the interior of the electronic device, and wherein the fluid includes particles;
an optical source that, during operation, provides an optical beam having a wavelength, wherein the optical source includes a laser;
an aperture that, during operation, receives the optical beam and to provide a diffracted optical beam in the interior of the electronic device;
a protective mechanism, having a top surface and a bottom surface, which, during operation, transmits the wavelength;
an imaging sensor, positioned beneath the bottom surface, which, during operation, captures one or more images that include diffraction patterns associated with a subset of the particles deposited on the top surface, wherein the subset includes multiple particles and the particles are stationary on the top surface; and
an integrated circuit, electrically coupled to the imaging sensor, which, during operation, analyzes the one or more images to determine information about the deposited particles, wherein the electronic device excludes a lens; and
wherein the integrated circuit uses signal processing to obtain an image of the subset of the particles with a resolution that is less than a resolution of the one or more images based on a superresolution technique.

17. The electronic device of claim 16, wherein the aperture includes a pin-hole aperture.

18. The electronic device of claim 16, wherein the resolution that is obtained using the superresolution technique is less than 2.5 μm.

19. The electronic device of claim 16, further comprising an optical filter, between the bottom surface and the imaging sensor, which, during operation, filters the diffracted optical beam after the protective mechanism.

20. An electronic-device-implemented method for obtaining information about particles, wherein the method comprises:
creating a flow of a fluid, having an average flow direction, into an interior of the electronic device, wherein the fluid includes particles;
providing an optical beam from an optical source in the electronic device, wherein the optical source includes a laser;
using an aperture in the optical source, generating a diffracted optical beam in the interior of the electronic device;
using an imaging sensor in the electronic device, capturing one or more images that include diffraction patterns associated with a subset of the particles deposited on a top surface of a protective mechanism positioned above the imaging sensor, wherein the subset includes multiple particles and the particles are stationary on the top surface; and
analyzing the one or more images to determine the information about the deposited particles, wherein the electronic device excludes a lens; and
wherein the analysis involves signal processing to obtain an image of the subset of the particles with a resolution that is less than a resolution of the one or more images based on a superresolution technique.

21. The method of claim 20, wherein the resolution that is obtained using the superresolution technique is less than 2.5 μm.
